(19) United States
(12) Patent Application Publication
(10) Pub. No.: US 2007/0296887 A1
(43) Pub. Date: Dec. 27, 2007

(54) POWER SUPPLY DEVICE, LED DRIVER, ILLUMINATION DEVICE, AND DISPLAY DEVICE

(75) Inventors: Shigeharu Nakao, Kyoto-shi (JP); Yuji Omiya, Kashihara-shi (JP)

Correspondence Address: FISH & RICHARDSON P.C., P.O. BOX 1022, MINNEAPOLIS, MN, 55440-1022, US

(73) Assignee: ROHM CO., LTD., Kyoto (JP)

(21) Appl. No.: 11/739,886

(22) Filed: Apr. 25, 2007

(30) Foreign Application Priority Data
Apr. 27, 2006 (JP) 2006-123440

(51) Int. Cl. G02F 1/1335; F21V 7/04; G05F 1/00

(52) U.S. Cl. 349/62; 315/291; 323/280; 362/623

(57) ABSTRACT

A power supply device has a regulator that performs conductivity control of an output transistor in such a way that a feedback voltage according to an output voltage is made equal to a reference voltage; a charge pump that produces the output voltage by stepping up an input voltage from the regulator; a detector that detects whether or not a control voltage of the output transistor has reached a threshold voltage; and a state controller that changes a step-up factor of the charge pump based on a comparison result of the detector. With this configuration, despite having a small-scale circuit configuration, the power supply device can appropriately perform state control of the charge pump.

This application is based on Japanese Patent Application No. 2006-123440 filed on Apr. 27, 2006, the contents of which are hereby incorporated by reference.

### BACKGROUND OF THE INVENTION

1. Field of the Invention

The present invention relates to power supply devices that produce a desired output voltage from an input voltage, and to LED (light-emitting diode) drivers, illumination devices, and display devices incorporating such power supply devices. For example, the present invention relates to an LED backlight system for liquid crystal displays.

2. Description of Related Art

FIG. 3 is a block diagram showing an example of a conventional LED driver.

As shown in this figure, a commonly used conventional LED driver is configured as follows. To obtain a desired output voltage Vout from an input voltage Vin, a regulator 101 to which an output voltage Vout is fed back produces from the input voltage Vin an input voltage Vin′ to be inputted to a charge pump 102, and first to n-th detectors 103-1 to 103-n individually detect the ratio between the input voltage Vin and the output voltage Vout, whereby state (step-up factor) control of the charge pump 102 is performed according to the detection result thus obtained.

Hereinafter, taking up as an example a case in which the state of the charge pump 102 is sequentially changed in three levels (step-up factors of 1, 1.5, and 2) by using the first and second detectors 103-1 and 103-2, the conventional state control described above will be specifically described.

First, the first detector 103-1 detects the ratio between the input voltage Vin and the output voltage Vout, and checks whether it is possible or not to keep the step-up factor of the charge pump 102 at 1 to obtain a desired output voltage Vout. That is, the first detector 103-1 checks whether or not the ratio of the input voltage Vin to the output voltage Vout is higher than a (with consideration given to the conversion efficiency of the regulator 101 and the charge pump 102, α>1). If the ratio of the input voltage Vin to the output voltage Vout is higher than α, the step-up factor of the charge pump 102 is kept at 1. On the other hand, if the ratio of the input voltage Vin to the output voltage Vout is lower than α, the step-up factor of the charge pump 102 is changed to 1.5.

After the step-up factor of the charge pump 102 is changed to 1.5, the second detector 103-2 detects the ratio between the input voltage Vin and the output voltage Vout, and checks whether it is possible or not to keep the step-up factor of the charge pump 102 at 1.5 to obtain a desired output voltage Vout. That is, the second detector 103-2 checks whether or not the ratio of the input voltage Vin to the output voltage Vout is higher than β(>1/1.5). If the ratio of the input voltage Vin to the output voltage Vout is higher than β, the step-up factor of the charge pump 102 is kept at 1.5. On the other hand, if the ratio of the input voltage Vin to the output voltage Vout is lower than β, the step-up factor of the charge pump 102 is changed to 2.

As another conventional technology related to LED drivers, JP-A-2004-022929 (hereinafter “Patent Document 1”) discloses and proposes a DC/DC step-up system that obtains a desired output voltage by feeding a cathode voltage of an LED back to an output voltage adjusting circuit.

Alternatively, JP-A-2005-039215 (hereinafter “Patent Document 2”) discloses and proposes a light-emitting diode driving method for driving, with a current mirror, a plurality of light-emitting diodes that are arranged in parallel and are coupled to an output terminal of the current mirror, wherein the light-emitting diode driving method includes the steps of: using a voltage at a control terminal of the current mirror as a reference voltage; boosting a voltage at an input terminal of the current mirror, fixing the difference between the voltages at the input and output terminals of the current mirror by using input terminals of the plurality of light-emitting diodes as a voltage feedback point, and keeping the voltage difference constant; and driving the plurality of light-emitting diodes by a voltage at the output terminal of the current mirror.

Certainly, with the conventional LED driver shown in FIG. 3, even when, for example, the input voltage Vin decreases (due to exhaustion of a battery, or the like), it is possible to produce a desired output voltage Vout from the input voltage Vin.

However, since the conventional LED driver described above is so configured as to perform state control of the charge pump 102 based on the ratio between the input voltage Vin and the output voltage Vout, the greater the number of levels in which the state of the charge pump 102 is changed, the greater the number of first to n-th detectors 103-1 to 103-n is required. This leads to an unduly large circuit scale.

In addition, the conventional LED driver described above performs feedback control of the regulator 101 and state control of the charge pump 102 with a sufficient margin given to the output voltage Vout, so that it can smoothly drive the LED connected thereto even when the forward voltage drop Vf of the LED is a little too high. As a result, the conventional LED driver described above supplies an output voltage Vout that is higher than necessary by the margin given thereto. This undesirably leads to lower efficiency.

Incidentally, the conventional technology of Patent Document 1 eliminates an unnecessary margin given to the output voltage Vout by performing feedback control of a step-up circuit based on the cathode voltage of an LED, and thereby improves efficiency. However, this document does not describe that the step-up circuit is a charge pump, and thus, quite naturally, does not suggest nor mention the above-described problems (a large circuit scale and lower efficiency) accompanied with an attempt to realize the state control of the charge pump and solutions to these problems.

The conventional technology of Patent Document 2 uses, instead of a charge pump, a current mirror for producing a drive voltage of an LED, and is therefore fundamentally different in configuration from that of the present invention.

### SUMMARY OF THE INVENTION

In view of the problems described above, an object of the present invention is to provide power supply devices that, despite having a small-scale circuit configuration, can appropriately perform state control of a charge pump, and to provide LED drivers, illumination devices, and display devices provided with such power supply devices.

To achieve the above object, according to one aspect of the invention, a power supply device includes: a regulator that includes an output transistor connected in series along a path from a terminal to which an input voltage is applied to a terminal from which an output voltage is outputted, and that performs conductivity control of the output transistor in such a way that a feedback voltage according to the output voltage is made equal to a predetermined reference voltage; a charge pump that produces the output voltage by stepping up a voltage inputted from the regulator; a detector that detects whether or not a control voltage of the output transistor has reached a predetermined threshold voltage; and a state controller that changes a step-up factor of the charge pump based on a comparison result of the detector.

Other features, elements, steps, advantages and characteristics of the present invention will become more apparent from the following detailed description of preferred embodiments thereof with reference to the attached drawings.

### BRIEF DESCRIPTION OF THE DRAWINGS

FIG. 1 is a block diagram showing an embodiment of a display device according to the invention;

FIG. 2 is a timing chart showing state control operation of this embodiment; and

FIG. 3 is a block diagram showing an example of a conventional LED driver.

### DETAILED DESCRIPTION OF PREFERRED EMBODIMENTS

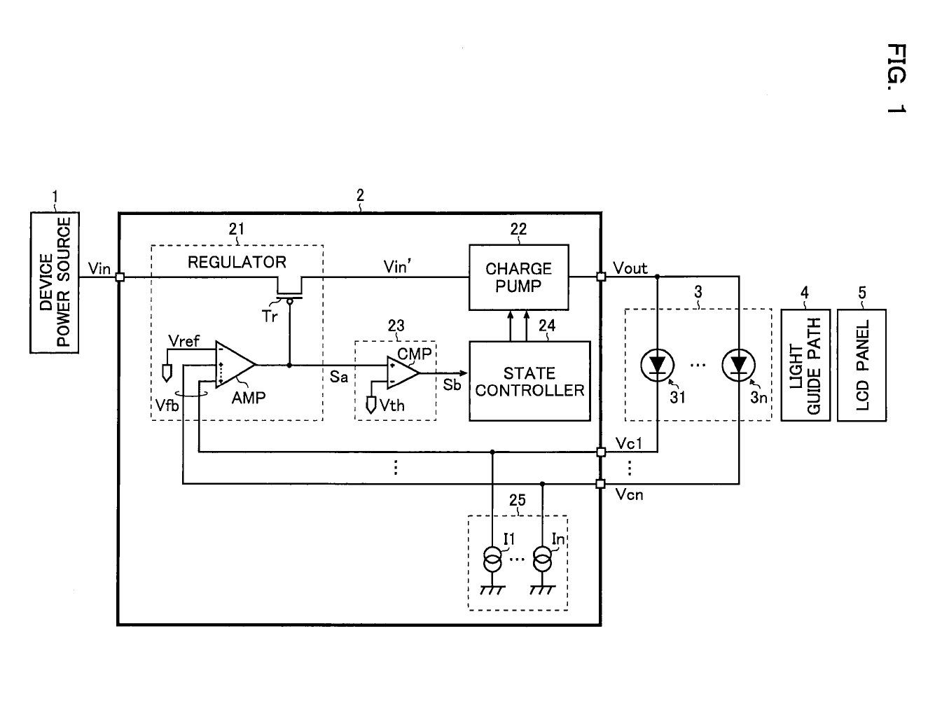

FIG. 1 is a block diagram showing an embodiment of a display device according to the invention. As shown in this figure, the display device of this embodiment is a transmissive liquid crystal display including a device power source 1, an LED driver IC 2, a light-emitting portion 3, a light guide path 4, and a liquid crystal display panel 5 (hereinafter “LCD (liquid crystal display) panel 5”).

The device power source 1 supplies electric power to the LED driver IC 2 and other parts of the display device; it may be an AC/DC converter that produces a DC (direct-current) voltage from a commercially distributed AC (alternating-current) voltage, or a battery such as a rechargeable battery.

Supplied with an input voltage Vin from the device power source 1, the LED driver IC 2 drives and controls LEDs 31 to 3n that form the light-emitting portion 3. The configuration and operation of the LED driver IC will be specifically described later.

The light-emitting portion 3 is composed of a plurality of LEDs 31 to 3n connected in parallel. The light-emitting portion 3 produces illumination light, which is used as backlight that illuminates the LCD panel 5 from behind via the light guide path 4. With this configuration in which the LED is used as a backlight, compared with a configuration in which a fluorescent tube or the like is used as a backlight, it is possible to offer such benefits as low electric power consumption, longer life, reduced amount of heat generated, and space saving.

Each of the LEDs 31 to 3n that form the light-emitting portion 3 is composed of three LED elements emitting red, green, and blue light respectively; it produces illumination light of a desired color (in this embodiment, white) by mixing together light emitted from these three LED elements. With the configuration in which such a white LED is used as a backlight, compared with a configuration in which a fluorescent tube or the like is used as a backlight, it is possible to expand the color reproduction range of the LCD panel 5.

The light guide path 4 allows Light produced by the light-emitting portion 3 to pass therethrough in such a way as to provide even illumination across the entire surface of the LCD panel 5. The light guide path 4 is formed with a reflecting sheet and a light guide sheet (a transparent sheet having a specially treated surface).

The LCD panel 5 is formed with two glass plates having liquid crystal sealed therebetween. By applying a voltage to the liquid crystal, the orientation of the liquid crystal molecules is changed in such a way as to increase/decrease the transmissivity of light radiated from the light-emitting portion 3 onto the back of the LCD panel 5 via the light guide path 4. In this way, the LCD panel 5 produces images. Note that the LCD panel 5 is controlled by an unillustrated LCD controller so as to produce images.

Next, the configuration and operation of the LED driver IC 2 will be described in detail.

As shown in FIG. 1, the LED driver IC 2 is composed of a regulator 21, a charge pump 22, a detector 23, a state controller 24, and a drive current generator 25.

The regulator 21 includes an output transistor Tr (in this embodiment, a P-channel field-effect transistor) and an amplifier AMP. The source of the transistor Tr is connected to a terminal to which the input voltage Vin is applied. The drain of the transistor Tr is connected, via the charge pump 22, to a terminal from which an output voltage Vout is outputted. The gate of the transistor Tr is connected to the output terminal of the amplifier AMP. The inverting input terminal (−) of the amplifier AMP is connected to a terminal to which a reference voltage Vref is applied. On the other hand, a plurality of non-inverting input terminals (+) of the amplifier AMP are each connected to corresponding one of the feedback terminals to which cathode voltages Vc1 to Vcn of the LEDs 31 to 3n are applied.

The charge pump 22 produces a desired output voltage Vout to be supplied to the anodes of the LEDs 31 to 3n by stepping up an input voltage Vin′ fed from the regulator 21 by using a charge transfer switch and a charge transfer capacitor (of which none is illustrated). The charge pump 22 of this embodiment is so configured that a state (step-up factor) thereof is changed in multiple levels (for example, step-up factors of 1, 1.5, and 2) according to an instruction from the state controller 24.

The detector 23 detects whether or not a gate voltage Sa of the output transistor Tr (an output voltage of the amplifier AMP) has reached a predetermined threshold voltage Vth by using a comparator CMP. The non-inverting input terminal (+) of the comparator CMP is connected to the gate of the output transistor Tr (the output terminal of the amplifier AMP). The inverting input terminal (−) of the comparator CMP is connected to a terminal to which the threshold voltage Vth is applied. The output terminal of the comparator CMP is connected to a terminal of the state controller 24 to which a comparison result signal is inputted.

The state controller 24 changes the state of the charge pump 22 based on a comparison result signal Sb from the detector 23.

The drive current generator 25 adjusts drive currents of the LEDs 31 to 3n individually by using constant current sources I1 to In. That is, to control the amount of light emitted from each of the LEDs 31 to 3n, it is necessary simply to adjust a value of current supplied from corresponding one of the constant current sources I1 to In.

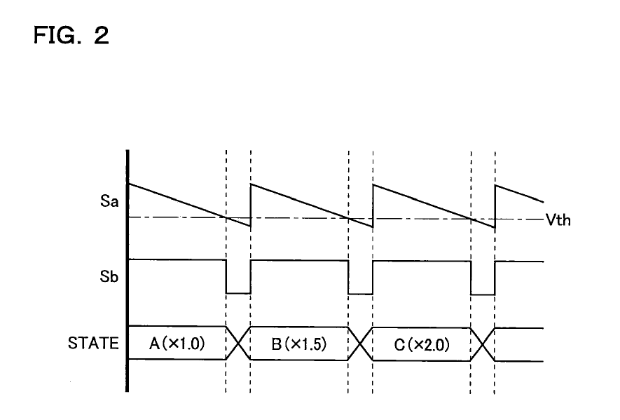

Now, how the LED driver IC 2 configured as described above controls the state of the charge pump 22 will be described in detail with reference to FIG. 2 as well as FIG. 1.

FIG. 2 is a timing chart showing the state control operation of this embodiment.

In the LED driver IC 2 configured as described above, the amplifier AMP included in the regulator 21 selects from among the cathode voltages Vc1 to Vcn of the LEDs 31 to 3n a cathode voltage having the lowest voltage value as a feedback voltage Vfb, and then produces a gate voltage Sa of the output transistor Tr in such a way that the feedback voltage Vfb is made equal to the predetermined reference voltage Vref.

More specifically, when the feedback voltage Vfb becomes higher than the reference voltage Vref, the amplifier AMP increases the gate voltage Sa so as to decrease the conductivity of the output transistor Tr; when the feedback voltage Vfb becomes lower than the reference voltage Vref, the amplifier AMP decreases the gate voltage Sa so as to increase the conductivity of the output transistor Tr.

As described above, in the LED driver IC 2 of this embodiment, the input voltage Vin′ needed by the charge pump 22 to obtain a desired output voltage Vout is produced by using the regulator 21 to which the cathode voltages Vcl to Vcn of the LEDs 31 to 3n are fed back.

Suppose that the state of the charge pump 22 is fixed at a given state. Then, as the input voltage Vin decreases (due to exhaustion of a battery, or the like), the gate voltage Sa of the output transistor Tr gradually decreases so as to increase the conductivity of the output transistor Tr.

When the gate voltage Sa becomes lower than the predetermined threshold voltage Vth, the logic of the comparison result signal Sb (that is, the output logic of the comparator CMP) produced by the detector 23 is changed from a high level to a low level.

The state controller 24 that monitors the comparison result signal Sb judges that, based on the falling edge of the comparison result signal Sb as a trigger, the output transistor Tr has reached maximum conductivity (or almost maximum conductivity), and that it will become impossible to obtain a desired output voltage Vout with the current state (step-up factor) of the charge pump 22. Thus, the state controller 24 gives an instruction to the charge pump 22 to change the current state to a next state (for example, change a step-up factor of 1 to a step-up factor of 1.5).

After the state of the charge pump 22 is changed in response to the instruction, the output voltage Vout increases, and accordingly the cathode voltages Vc1 to Vcn of the LEDs 31 to 3n increase. As a result, the gate voltage Sa of the transistor Tr becomes higher than the threshold voltage Vth again, and accordingly the comparison result signal Sb from the detector 23 is restored to a high level from a low level.

By thereafter keeping operating in the same manner as described above, conductivity control of the output transistor Tr by the regulator 21 and state control of the charge pump 22 are performed in a cooperative manner based on the result of comparison between the feedback voltage Vfb and the reference voltage Vref, so as to obtain a desired output voltage Vout from the input voltage Vin.

It is to be noted that, although, in FIG. 2, the length of a state transition period during which one state is changed to another is exaggerated to make it easy to see the logic change (trigger edge) of the comparison result signal Sb, actual state transition takes place instantaneously.

As described above, the LED driver IC 2 of this embodiment includes: as a power supply means for supplying drive power to the LEDs 31 to 3n, the regulator 21 that includes the output transistor Tr connected in series along a path from the terminal to which the input voltage Vin is applied to the terminal from which the output voltage Vout is outputted, and that performs conductivity control of the output transistor Tr in such a way that the feedback voltage Vfb (in this embodiment, the lowest voltage of the cathode voltages Vcl to Vcn) according to the output voltage Vout is made equal to the predetermined reference voltage Vref; the charge pump 22 that produces the output voltage Vout by stepping up the voltage Vin′ inputted from the regulator 21; the detector 23 that detects whether or not the gate voltage Sa of the output transistor Tr has decreased to the predetermined threshold voltage Vth; and the state controller 24 that changes a step-up factor of the charge pump 22 based on the comparison result signal Sb of the detector 23.

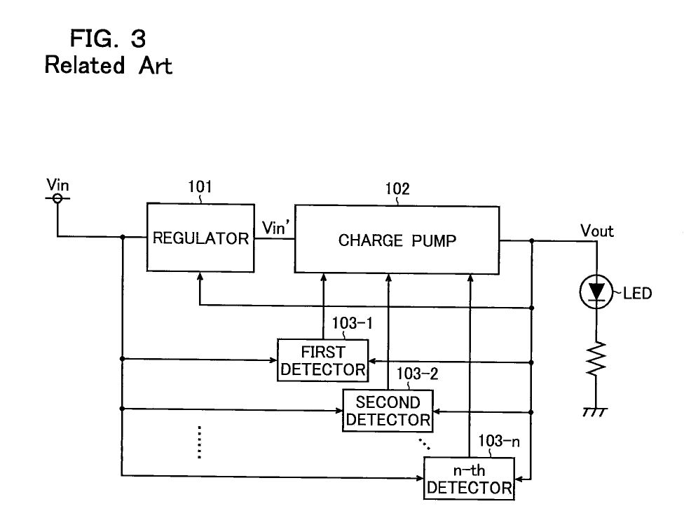

With this configuration, unlike the conventional configuration (see FIG. 3) in which the state control of the charge pump 102 is performed based on the ratio between the input voltage Vin and the output voltage Vout by using the first to n-th detectors 103-1 to 103n provided according to the number of states, it is possible to appropriately perform, despite having a small-scale circuit configuration, the state control of the charge pump 22 by using the single detector 23. In addition, since the state controller 24 additionally provided in the present invention can be formed as a simple logic circuit, it is possible to reduce the total circuit scale and hence the costs of the LED driver IC 2.

In the LED driver IC 2 of this embodiment, to the amplifier AMP, not the output voltage Vout but the lowest voltage value of the cathode voltages V to Vcn of the LEDs 31 to 3n is fed back as the feedback voltage Vfb. With this configuration, it is possible to produce the optimal output voltage Vout for reliably driving, of the LEDs 31 to 3n actually connected to the device, the one having the highest forward voltage drop Vf. This helps reduce an unnecessary margin given to the output voltage Vout and thus improve efficiency, contributing to a reduction in the electric power consumption of illumination devices and display devices provided with the LED driver IC 2.

In particular, by applying the invention to illumination devices incorporated in electronic apparatuses such as PDAs (personal digital/data assistants) and portable telephone terminals and using a battery as the device power source 1, it is possible not only to prolong the battery life of the electronic apparatuses but also to make the electronic apparatuses thinner and smaller.

The embodiment described above deals with an example in which the invention is applied to a transmissive liquid crystal display device. This, however, is not meant to limit the application of the invention in any way; the invention finds wide application in power supply devices, illumination devices, or display devices of any other type.

The invention may be practiced in any other manner than specifically described above, with any modification or variation made within the spirit of the invention.

For example, the embodiment described above deals with an example in which an LED that produces white light by mixing together red, green, and blue light is used. However, needless to say, the invention is applicable also to a configuration using an LED that emits light of a desired color by mixing together light of any other color than is specifically described above or an LED that emits monochromatic light.

The invention offers the following advantages: it helps realize power supply devices that, despite having a small-scale circuit configuration, can appropriately perform state control of a charge pump; hence it helps realize LED drivers, illumination devices, and display devices provided with such power supply devices.

In terms of industrial applicability, the invention is useful in making smaller and more efficient power supply devices provided with a charge pump. This makes smaller LED drivers, illumination devices, and display devices provided with such power supply devices possible, and allows them to operate with less electric power consumption. The LED drivers and the illumination devices according to the invention can be used in constructing, for example, a backlight system for liquid crystal displays, and some examples of the display devices provided therewith are liquid crystal television receivers, liquid crystal displays of PDAs, and liquid crystal displays of portable telephones.

While the present invention has been described with respect to preferred embodiments, it will be apparent to those skilled in the art that the disclosed invention may be modified in numerous ways and may assume many embodiments other than those specifically set out and described above. Accordingly, it is intended by the appended claims to cover all modifications of the present invention which fall within the true spirit and scope of the invention.

What is claimed is:

1. A power supply device, comprising:
a regulator that comprises an output transistor connected in series along a path from a terminal to which an input voltage is applied to a terminal from which an output voltage is outputted, and that performs conductivity control of the output transistor in such a way that a feedback voltage according to the output voltage is made equal to a predetermined reference voltage;
a charge pump that produces the output voltage by stepping up a voltage inputted from the regulator;
a detector that detects whether or not a control voltage of the output transistor has reached a predetermined threshold voltage; and
a state controller that changes a step-up factor of the charge pump based on a comparison result of the detector.

2. An LED driver, comprising:
a power supply device that supplies drive power to at least one light-emitting diode,
wherein the power supply device comprises:
a regulator that comprises an output transistor connected in series along a path from a terminal to which an input voltage is applied to a terminal from which an output voltage is outputted, and that performs conductivity control of the output transistor in such a way that a feedback voltage according to the output voltage is made equal to a predetermined reference voltage;
a charge pump that produces the output voltage by stepping up a voltage inputted from the regulator;
a detector that detects whether or not a control voltage of the output transistor has reached a predetermined threshold voltage; and
a state controller that changes a step-up factor of the charge pump based on a comparison result of the detector,
wherein the power supply device supplies the output voltage to the at least one light-emitting diode.

3. The LED driver of claim 2, wherein
the feedback voltage is a cathode voltage of the at least one light-emitting diode.

4. The LED driver of claim 3, wherein
the at least one light-emitting diode comprises a plurality of light-emitting diodes arranged in parallel, and
the feedback voltage is, of the cathode voltages of the light-emitting diodes, a cathode voltage having a lowest voltage value.

5. An illumination device, comprising:
a light-emitting diode;
an LED driver that drives and controls the light-emitting diode; and
a device power source that supplies electric power to the LED driver,
wherein the LED driver comprises:
a power supply device that supplies drive power to the light-emitting diode,
wherein the power supply device comprises:
a regulator that comprises an output transistor connected in series along a path from a terminal to which an input voltage supplied from the device power source is applied to a terminal from which an output voltage is outputted, and that performs conductivity control of the output transistor in such a way that a feedback voltage according to the output voltage is made equal to a predetermined reference voltage;
a charge pump that produces the output voltage by stepping up a voltage inputted from the regulator;
a detector that detects whether or not a control voltage of the output transistor has reached a predetermined threshold voltage; and
a state controller that changes a step-up factor of the charge pump based on a comparison result of the detector,
wherein the power supply device supplies the output voltage to the light-emitting diode.

6. The illumination device of claim 5, wherein
the device power source is a battery.

7. A display device, comprising:
a display panel; and
an illumination device that illuminates the display panel,
wherein the illumination device comprises:
a light-emitting diode;
an LED driver that drives and controls the light-emitting diode; and
a device power source that supplies electric power to the LED driver,
wherein the LED driver comprises:
a power supply device that supplies drive power to the light-emitting diode,
wherein the power supply device comprises:
a regulator that comprises an output transistor connected in series along a path from a terminal to which an input voltage supplied from the device power source is applied to a terminal from which an output voltage is outputted, and that performs conductivity control of the output transistor in such a way that a feedback voltage according to the output voltage is made equal to a predetermined reference voltage;
a charge pump that produces the output voltage by stepping up a voltage inputted from the regulator;
a detector that detects whether or not a control voltage of the output transistor has reached a predetermined threshold voltage; and
a state controller that changes a step-up factor of the charge pump based on a comparison result of the detector,
wherein the power supply device supplies the output voltage to the light-emitting diode.
